(19) United States
(12) Patent Application Publication
(10) Pub. No.: US 2002/0170170 A1
(43) Pub. Date: Nov. 21, 2002

(54) Machine for the automatic tension of belts for the furniture industry

(76) Inventor: Giuseppe Seroldi, Seregno (IT)

Correspondence Address: NOTARO & MICHALOS P.C., Empire State Building, Suite 6902, 350 Fifth Avenue, New York, NY, 10118-6985, US

(21) Appl. No.: 10/123,566

(22) Filed: Apr. 16, 2002

(30) Foreign Application Priority Data
May 15, 2001 (IT) MI2001A 000996

(51) Int. Cl. B23P 19/00

(52) U.S. Cl. 29/822

(57) ABSTRACT

This invention relates to an improved machine for the automatic tension of belts for the furniture industry. The machine at issue is capable of automatically feeding a plurality of belts (4) to fasten to the frames (2) used to produce seats or backrests of armchairs, sofas or similar, and which is equipped with means (9) suited to strain the belts, once these have been fastened by an end to the frame, all with the same force.

The machine is characterized by the fact that each tensioner (9) operates on a single belt and that said means are pneumatically activated by means of a common circuit, so that each tensioner applies on the belt the same force of traction.

This invention relates to an improved machine for the automatic tension of belts for the furniture industry.

The machine at issue is capable of automatically feeding a plurality of belts to fasten to the frames used to produce seats or backrests of armchairs, sofas or similar, and which is equipped with means suited to strain the belts, once these have been fastened by an end to the frame, all with the same force.

The machine is characterised by the fact that each tensioner operates on a single belt and that said means are pneumatically activated by means of a joint circuit, so that each tensioner applies on the belt the same force of traction.

According to one embodiment of the invention, the belts travel around a couple of rollers, coiling them in the opposite direction around both the rollers and the tension devices consist of the same number of pistons, each of them engaging a belt, folding it up until it overlaps on the portion of belt coiled up on said support rollers, in such a way as to block it by friction and, afterwards, to strain it with predetermined force.

The invention also provides for means suited to exclude one or more of said tensioners, in such a way as to adapt such machine to frames having a different number of belts and means suited to automatically adjust the height of the work-top, in order to facilitate the operators’work of fastening of the belt to the piece of furniture.

As it is known, the production of pieces of furniture such as armchairs, sofas or similar, provides for the frequent use—to produce the seats or the backrests—of elastic belts, which are fastened to the frame of the piece of furniture, by fastening them just close to the two opposite sides of said frame.

The procedure consists in fastening one end of the belt to one side of the frame, applying a traction with a predetermined force, fastening the belt to the opposite side and then cutting it.

In order to speed up these operations, tension machines are known, one of them is described in the Italian utility model no. 221846 of the same applicant.

In this machine a series of spools feed the belts to a tension roller, which rotates around its axis and to which a bar—kept at a certain distance from the roller surface—is applied, in such a way as to allow the insertion of the belts between roller and bar, which belts are folded up backwards and then fastened to the first side of the frame.

By making the roller rotate, said roller strains the belts with a force, which is adjusted by intervening on the extent of the roller rotation by means of a mechanical limit switch.

These known machines, on the other hand, allow to adjust, at subsequent intervals, only the overall traction applied to the belts, so that it can happen that in the same frame certain belts are more or less strained then the others, for example because of a different resistance of an elastic belt, or of an unequal tension of said belts.

This invention belongs to this field; and relates to an improved tension machine, wherein to each belt corresponds a single tensioner and all these devices are pneumatically activated by a common circuit, so that each device strains the respective belt with the same force as the others, regardless of the resistance or the way such belt has been fastened.

The invention provides for means suited to exclude one or more of these tension devices in such a way as to adapt the machine to frames requiring a different number of belts and also devices suited to adjust the work-top height in order to facilitate the operators’ work of fastening of the frame belts.

These and other characteristics will be set forth with further details in the following description, supplied by way of example but without any limitation thereto, with reference to the annexed figures in which:

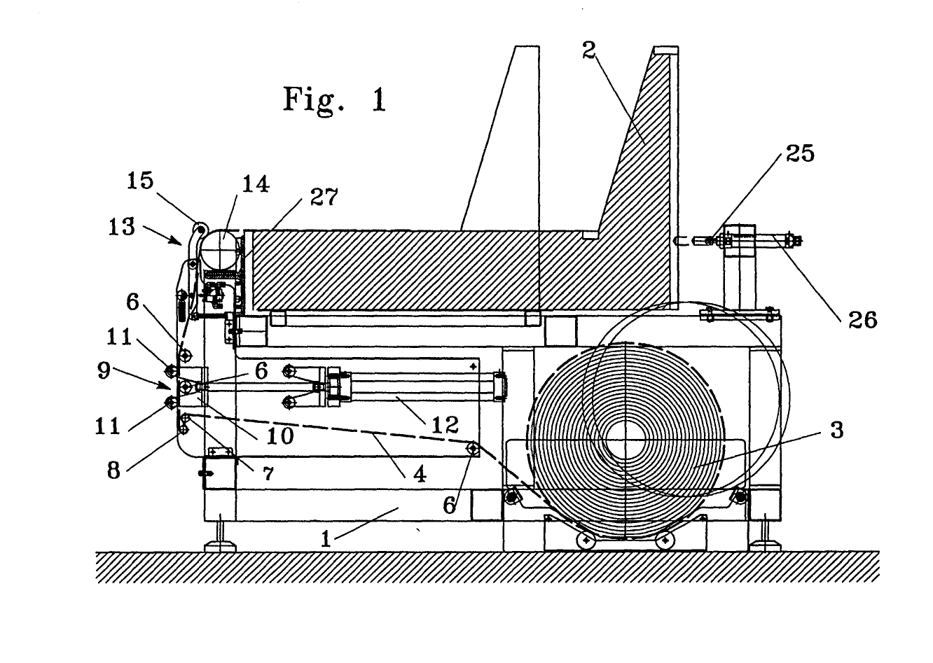

FIG. 1 schematically shows the side view of a tension machine according to the invention;

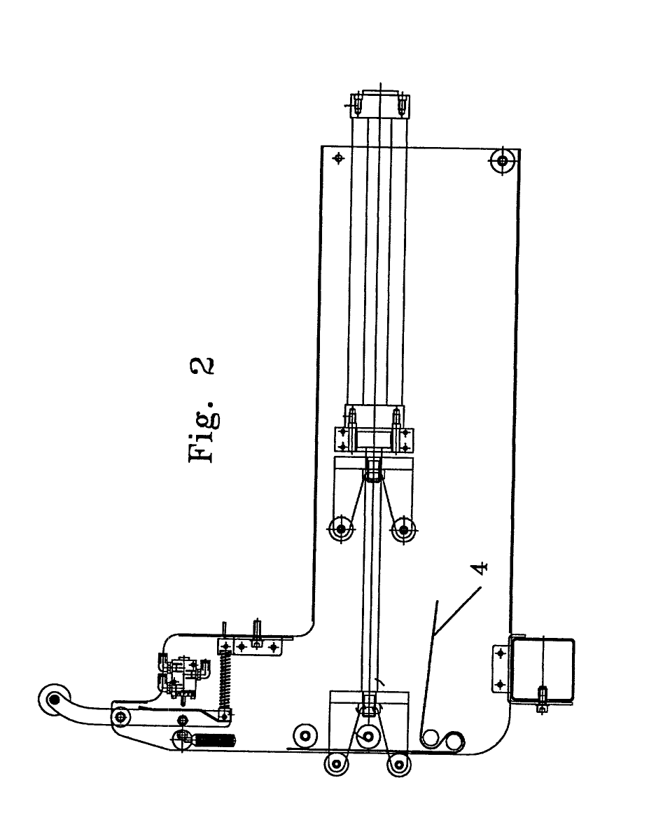

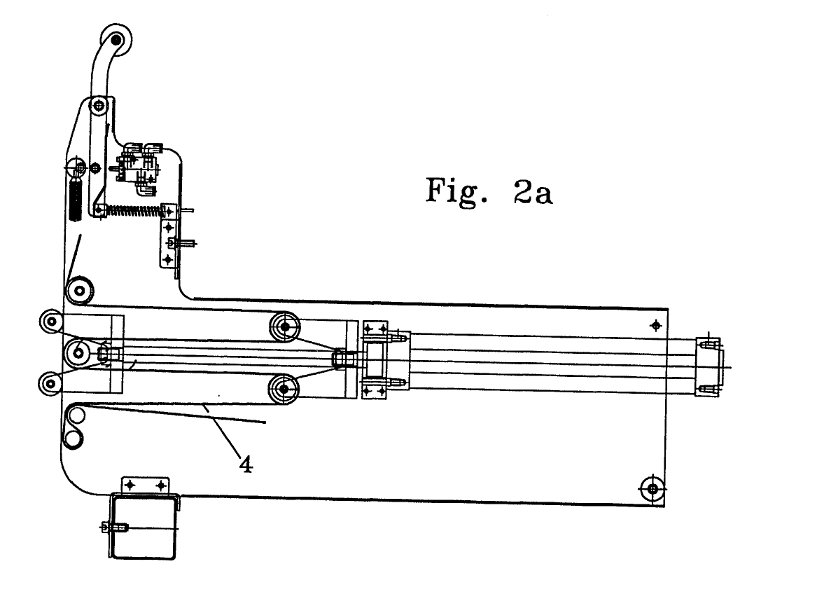

FIGS. 2 and 2A show a detail of the tension devices in two different positions;

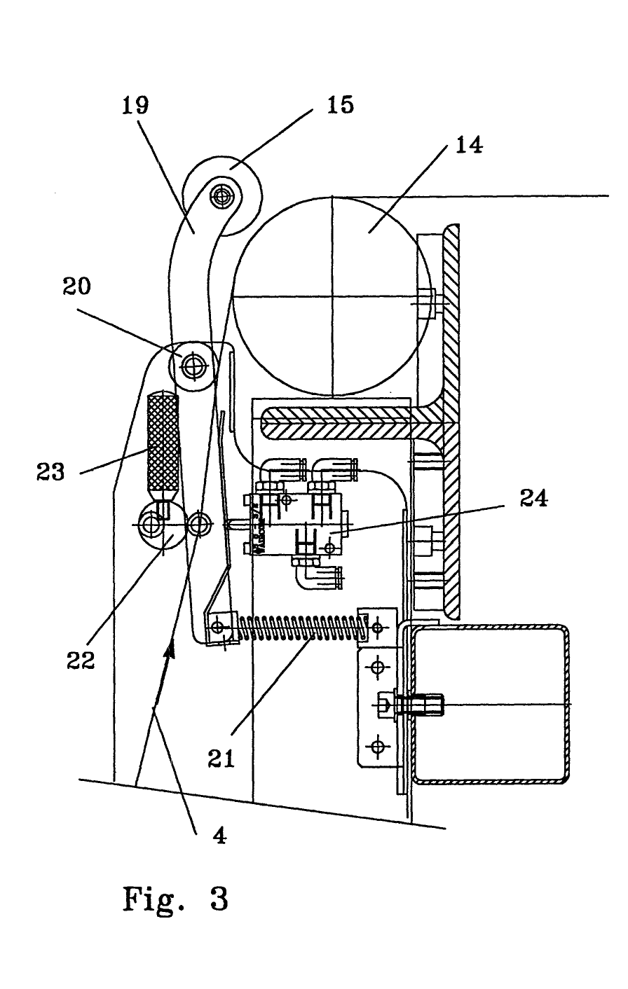

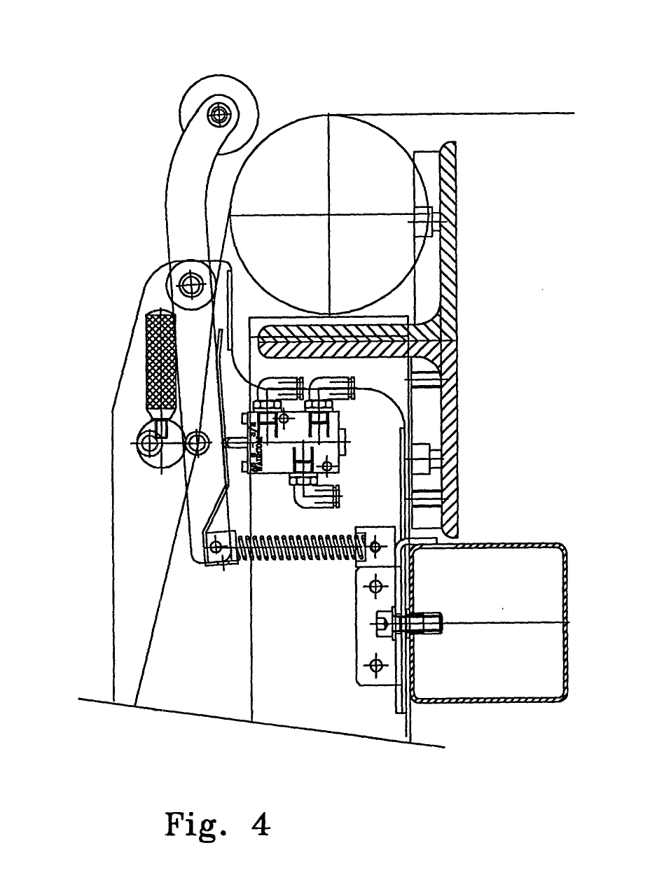

FIGS. 3 and 4 show a detail of the automatic feeding devices of the belts, respectively in disengaged position and in working position;

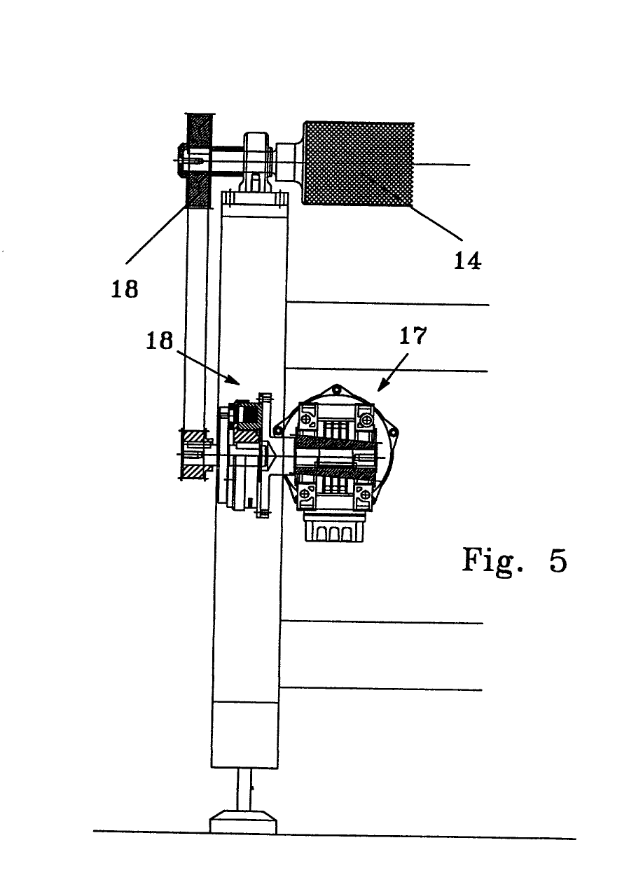

FIG. 5 shows the activation system of the feeding devices of the belts;

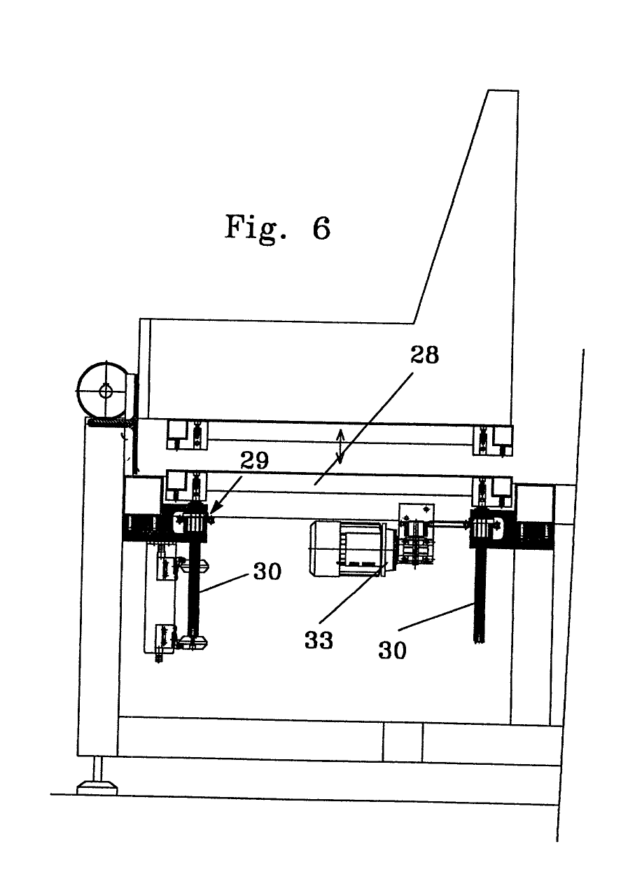

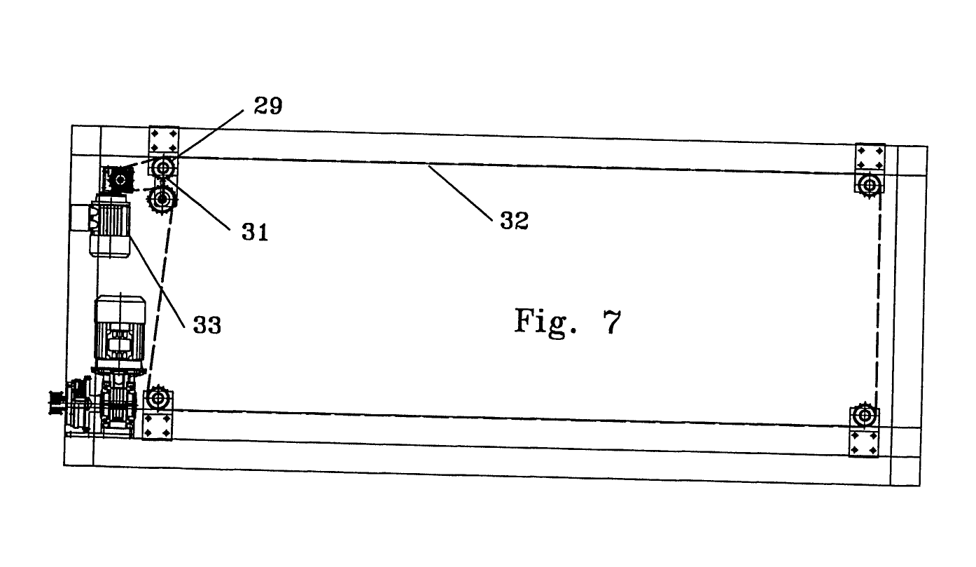

FIGS. 6 and 7 show the top view and the plan view of the devices adjusting the work-top height respectively.

With reference to FIG. 1, 1 indicates the machine frame, on which the structure 2 of the piece of furniture to which the belts must be applied is assembled, said belts in their turn being fed by a spool indicated with 3.

FIG. 1 shows the path of the belts 4, which, being driven by a series of idle rollers, indicated with 6, travel around a first contrast roller 7 and hence coil up in the opposite direction, around a second roller 8 placed beside the previous one.

Around the roller 8, the belts make an almost complete round and come back travelling along the roller 7.

Downstream the rollers 7 and 8, the belts 4 are engaged by a tension device 9 consisting of a support 10 with a couple of rollers 11 engaging from the outside the belt and which is subject to the operation of a piston 12 controlling the movement of the support 10 so that it deviates the belt rightwards in FIG. 1, so that the portion of belt downstream the roller 8 presses on the portion of belt coiling around the roller 7.

The details are better visible in FIGS. 2 and 2a showing in details the travel of the belt with the tensioner respectively in the position of feeding and straining of the belts.

At the exit of the tensioner 10, the belt arrives to a feeding device which is indicated as a whole with 13 and which essentially consists of a driving roller 14 engaging the belt in order to drive it towards the working area and of a pressor 15, which can be deactivated, pressing the belt against the roller 14.

The details of said device are shown in FIGS. 3, 4 and 5.

The roller 14 is driven, by means of a sheave transmission 16, by a motor reducer group 17 fastened to the machine frame and provided with an electromagnetic clutch.

The roller 15 is mounted on an arm 19, which is hinged in 20 to the machine frame and is subject to the force of a spring 21 which makes the arm rotate (clockwise in FIG. 3) in such a way as to press the roller 15 against the roller 14.

A cam or eccentric device 22, equipped with a handle 23, allows to block the arm 19 in an idle position shown in FIG. 3, in which the roller 15 is disengaged by the roller 14, which can therefore rotate without dragging the belt 4.

In this position the arm 19 acts on a stop valve 24 inserted into the circuit which feeds compressed air to the piston 12 of the tensioner, to block the air feeding and therefore exclude the working of said tensioner.

On the top of the machine there is a blocking device of the piece of furniture shown in FIG. 1, consisting of a pressor 25 or similar, pneumatically activated by means of a piston 26, suited to block the frame of the piece of furniture against a fixed stop plate 27 in order to prevent the returning action of the elastic belts during the tension phase from stripping away the frame with risks of accidents.

The machine according to the invention also provides for the possibility to adjust the height of the work-top which the frame rests on, to make the operators’ work more comfortable.

To this end the structure of the work-top, shown with 28 in FIG. 6, is mounted on a series of nuts 29 and threaded shaft 30 which allow to adjust the height of the work-top 28, keeping it always perfectly horizontal.

The nuts 29 are equipped with a toothing 31 (FIG. 7), which is engaged by a chain 32 activated by a geared motor indicated with 33.

The operation is the following.

The operator adjusts the height of the work-top 28 according to his needs, making the nuts 29 rotate by means of the geared motor 33.

The subsequent sliding of the shafts 30 brings the work-top at the desired height.

The operator then arranges the frame 2 on the work-top 28 and blocks it by means of the pressor 25, activated by the pneumatic actuator 26.

At this point, according to the size of the frame, the required belts are selected by means of the cam elements 22 which block the respective arms 19 so that the respective springs 21 make the arms press on the pressure rollers 15 against the feeding roller 14.

Further to the arms 19 rotation, the respective valves 24 open the compressed air outlet to the pistons 12 of the tension devices.

On the other hand, the remaining feeding devices, just close to the belts not being used, are kept in the disengagement positions of the pressure rollers shown in FIG. 3, with the arm 19 which activates the valves 24 to block the air feeding to the tensioners.

The operator makes the belt pass around the rollers 7 and 8, and therefore among the rollers 11 of the tensioner and the guide rollers 6, to arrive then on the feeding roller 14.

At this point the machine can be activated.

The activation of the motor 17 makes the roller 14 rotate, which simultaneously feeds all the belts which are kept pressed by the pressors 15.

When the belts arrive just close to the more distant edge of the frame, the motor 17 stops and the operator fastens the belts to the frame 2.

The belts shall be now strained and this operation is simply carried out by feeding the fluid under pressure to the piston 12.

This operation causes the displacement (on the right in FIG. 1) of the tensioner 10, which reaches the position shown in FIG. 4, with the rollers 11 pulling the belt inwards the machine.

The roller 11 placed at the base of the tensioner causes the belt, placed upstream the roller 8, to jam against the portion of the belt travelling on the roller 7 thus blocking it by friction.

In addition, both the rollers 11 apply a traction to the belt which is therefore strained with a force proportional to the air pressure into the piston 12.

Since all the pistons 12 are fed by a common circuit, the pressure will be the same as for all said pistons and, accordingly, the force of traction applied to the belts will be the same as for all said belts, regardless of the features of the single belts.

At this point the operator may fasten the belts also to the second side of the frame and subsequently cut them. A skilled in the art may make changes and different versions, which shall be considered as included within the competence of this invention.

1. Machine for the automatic tension of belts for the furniture industry, of the kind comprising means (25, 26) suited to hold the frame (2) of a piece of furniture, means (13) suited to feed a plurality of belts to be fastened to said frame, and means (9) suited to strain said belts once these have been fastened by an end to the frame, characterised by the fact that devices are provided, suited to strain each a single belt, with predetermined force.

2. Machine for the tension of belts according to the claim 1 characterised by the fact to be equipped with means (9) suited to singularly strain all the belts with the same force.

3. Machine for the straining of belts according to the claim 2, characterised by the fact to be equipped with means (24, 21) suited to simultaneously activate all said tensioners.

4. Machine for the tension of belts according to the claim 2, characterised by the fact that said tensioners (9) are pneumatically activated by means of a common circuit.

5. Machine for the tension of belts according to each of the previous claims wherein the belts travel around a series of guide rollers (6) and coil up in the opposite direction around at least one couple of rollers (7, 8) placed side by side, characterised by the fact that each of said belts is subject to the action of tensioners (9) pulling said belts, so that each of them be overlapped on a portion of belt at the top of said tensioners to block it by friction against the respective guide rollers, and afterwards strain the portion of belt included among said guide rollers and the piece of furniture, with predetermined force, the same for all the belts.

6. Tension machine according to the claim 5, characterised by the fact that said tension means (9) comprise a support (10) activated by a pneumatic piston (12) and equipped with one or more rollers (11) applying a traction on one side of the belt, said traction making said belt to overlap on a portion of belt on the top, blocking it by friction against the respective support.

7. Tension machine according to each of the previous claims characterised by the fact to be equipped with means (13) suited to automatically feed the belts, said means can be singularly inserted.

8. Tension machine according to the claim 7 wherein said means (13) of feeding of the belts comprise a feeding roller (14) on which the belts and a plurality of pressure rollers (15) rest on, one for each belt, suited to press said belts against said feeding roller.

9. Tension machine according to the claim 8, characterised by the fact to be equipped with cam means (22) suited to singularly disengage said pressure rollers (15) from said belts.

10. Tension machine according to the claim 9, characterised by the fact that said pressure rollers (15) are mounted on an arm (19) subject, on one side, to the operation of means (21) suited to operate on said arm to press said rollers (15) against said feeding roller (14), and on the other side to the operation of cam means (22) suited to block said arms in a disengagement position of said pressure rollers, in said disengagement position, said arms activate means (24) suited to block the feeding of the fluid under pressure to the respective tensioners.

11. Tension machine according to any one of the previous claims, characterised by the fact to be equipped with means (25, 26) suited to block the frame of the piece of furniture during the tension of the belts.

12. Tension machine according to the claim 11, characterised by the fact that said means consist of one or more pressors (25) suited to block the frame of the piece of furniture against a stop plate (27), said pressure being activated by the same number of pistons (26).

13. Machine according to each of the previous claims, characterised in that the support plane (28) of the piece of furniture mounted on a plurality of threaded shafts (30) engaged by the same number of nuts (29) mounted on the machine frame, means (32) being provided, suited to simultaneously rotate said nuts (29).

14. Machine according to the previous claim, wherein said means consist of a chain (32) activated by a geared motor (33) and which simultaneously engages said nuts (29).
